(19) United States
(12) Patent Application Publication
(10) Pub. No.: US 2016/0206904 A1
(43) Pub. Date: Jul. 21, 2016

(54) EXTENDED DISCHARGE FIRE PROTECTION SYSTEM AND METHOD

(71) Applicant: Carrier Corporation, Farmington, MA (US)

(72) Inventors: Joseph Senecal, Wellesley, MA (US); David Vanzandt, Ashland, MA (US)

(73) Assignee: Carrier Corporation, Farmington, MA (US)

(21) Appl. No.: 14/984,074

(22) Filed: Dec. 30, 2015

Related U.S. Application Data
(60) Provisional application No. 62/103,640, filed on Jan. 15, 2015.

(51) Int. Cl. A62C 3/00; A62C 35/64

(52) U.S. Cl. CPC A62C 3/00; A62C 35/645

(57) ABSTRACT

A method of fire protection for an enclosure is disclosed that includes the steps of introducing an initial amount of a gaseous agent into an enclosure to achieve a predetermined concentration level for a given hold time of the enclosure, and periodically introducing a supplemental amount of the gaseous agent into the enclosure to restore the concentration of gaseous agent in the enclosure to the predetermined level, thereby extending fire protection for the enclosure beyond the enclosure's hold time.

### CROSS-REFERENCE TO RELATED APPLICATION

The subject invention claims the benefit of priority from U.S. Provisional Patent Application Ser. No. 62/103,640 filed Jan. 15, 2015, the disclosure of which is herein incorporated by reference in its entirety.

### BACKGROUND OF THE INVENTION

1. Field of the Invention

The subject invention is directed to a system and method of fire protection for an enclosure, and more particularly, to a system and method for extending fire protection for the enclosure beyond the enclosure's rated hold time.

2. Description of Related Art

Total flooding fire suppression systems are designed and installed in accordance with widely published standards. Annex C of NFPA 2001 and Annex E of ISO 14520 are the principal guides to verify an enclosure's integrity. Total flooding fire suppression involves the discharge of a clean extinguishing agent that is typically required to provide protection within the design envelope for a minimum time period, usually for a minimum period of ten minutes or for a time period sufficient to allow for response by trained personnel, normally referred to as the “hold time.” The hold time may be specified as the period of time required for the clean agent concentration to drop to a specified threshold (e.g., 85% of the initial discharge concentration) at a specified height in the enclosure (often chosen as the point of highest combustibles or at some other specified height within the enclosure).

It is known that in some fire protection applications there is a need to extend the period of fire protection within an enclosure beyond the initial hold time. Common practice is to employ a secondary and independent supply of agent, pipe system, and nozzle to deliver agent to an enclosure continuously at a reduced rate in an attempt to compensate for agent lost through leakage and maintain agent concentration throughout the enclosure at or above a minimum required level for the length of time that fire protection must be maintained.

However, there are risks associated with this type of extended discharge system. It is typically not tested, and there is no assurance that there will be adequate turbulence in the room to mix the gases. The discharge rate slows as the supply cylinder becomes depleted, and the discharge rate could fall below the enclosure's leakage rate. In addition, the gas concentration can fall below the minimum target concentration for the enclosure. Consequently, the extended fire protection afforded by the prior continuous discharge system is relatively unpredictable.

It would be beneficial to provide an extended discharge fire protection system that mitigates the risks associated with the prior art system, and which provides a more predictable degree of fire suppression beyond the enclosure's rated hold time.

### SUMMARY OF THE INVENTION

The subject invention is directed to a fire protection system for an enclosure that includes a controller for regulating the introduction of a gaseous agent into an enclosure having a given hold time, which is the period of time following introduction of gaseous agent into the enclosure until the concentration of gaseous agent in the enclosure falls below a minimum concentration level. Among other things, the controller is adapted and configured to monitor a smoke detection device, or other means of fire detection, located within the enclosure. The system further includes a primary supply source operatively associated with the controller and containing an initial amount of a gaseous agent sufficient to achieve a predetermined initial concentration level of gaseous agent in the enclosure that is expected to persist in sufficient concentration and distribution within the enclosure for the hold time.

The system also includes a secondary supply source operatively associated with the controller and configured to periodically discharge a supplemental amount of the gaseous agent into the enclosure that is sufficient to restore the concentration of gaseous agent in the enclosure to the predetermined initial concentration level and thereby extend fire protection for the enclosure beyond the enclosure's hold time. Preferably, the supplemental amount of gaseous agent is sufficient to restore the concentration of gaseous agent in the enclosure to a level at or above a minimum fraction of a minimum design concentration (MDC) at a height of a highest protected hazard component in the enclosure.

In one embodiment of the invention, the secondary supply source is a single secondary agent supply reservoir, and a control valve is operatively associated with the secondary agent supply reservoir and the controller for periodically discharging gaseous agent from the secondary agent supply reservoir.

In another embodiment of the invention, the secondary supply source is a plurality of secondary agent supply reservoirs, and the controller is adapted and configured to sequentially discharge the plurality of secondary agent supply reservoirs into the enclosure. In one instance the controller is adapted and configured to sequentially discharge the plurality of secondary agent supply reservoirs into the enclosure in time intervals of equal duration.

In another instance, the controller is adapted and configured to sequentially discharge the plurality of secondary agent supply reservoirs into the enclosure in time intervals that vary in duration. In either instance, the controller is adapted and configured to discharge a supplemental amount of the gaseous agent into the enclosure for a predetermined period of time.

In either embodiment, the fire protection system may include a device or sensor for detecting or otherwise sensing the concentration of gaseous agent in the enclosure, and the controller may be adapted and configured to periodically discharge the single secondary agent supply reservoir, or to sequentially discharge a plurality of secondary agent supply reservoirs, upon detecting or otherwise sensing the concentration of gaseous agent in the enclosure falling below a minimum concentration level.

In one embodiment of the invention, the primary supply source and the secondary supply source are connected in series. In this instance, the primary supply source is preferably located upstream from the secondary supply source, and a check valve is positioned to fluidly isolate the primary supply source from the secondary supply source. In another embodiment of the invention, the primary supply source and the secondary supply source are connected in parallel.

The subject invention is also directed to a method of fire protection for an enclosure, which includes the steps of introducing an initial amount of a gaseous agent into an enclosure to achieve a predetermined concentration level for a given hold time of the enclosure, and periodically introducing a supplemental amount of the gaseous agent into the enclosure to restore the concentration of gaseous agent in the enclosure to the predetermined level, thereby extending fire protection for the enclosure beyond the enclosure's hold time.

In one instance, the supplemental amount of gaseous agent is periodically introduced into the enclosure in time intervals of equal duration. In another instance, the supplemental amount of gaseous agent is periodically introduced into the enclosure in time intervals that vary in duration. In either instance, the supplemental amount of gaseous agent is periodically introduced into the enclosure for a predetermined period of time.

The method of fire protection may include detecting or otherwise sensing the concentration of gaseous agent in the enclosure, and periodically discharging the secondary agent supply reservoir, or sequentially discharging a plurality of secondary agent supply reservoirs, upon detecting or otherwise sensing the concentration of gaseous agent in the enclosure falling below a minimum concentration level.

Preferably, the method includes the step of determining a minimum design concentration (MDC) and hold time for the enclosure, and the supplemental amount of gaseous agent is periodically introduced into the enclosure in a sufficient amount and for a sufficient duration of time to restore the concentration of gaseous agent in the enclosure to a level at or above a minimum fraction of the MDC at a height of a highest protected hazard component in the enclosure.

These and other features of the system and method of the subject invention and the manner in which it is manufactured and employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the subject invention without undue experimentation, preferred embodiments thereof will be described in detail herein below with reference to certain figures, wherein:

FIG. 1 is an illustration of an enclosure protected by a gaseous agent fire extinguishing system configured in accordance with an embodiment of the subject invention;

FIG. 2 is an illustration of the protected enclosure of FIG. 1, wherein a primary supply source of gaseous agent is shown discharging an initial amount of a gaseous agent sufficient to achieve a predetermined initial concentration level in the enclosure;

FIG. 3 is an illustration of the protected enclosure of FIG. 1, a few minutes after the initial agent discharge shown in FIG. 2, wherein the concentration of gaseous agent has decreased in the upper part of the enclosure;

FIG. 4 is an illustration of the protected enclosure of FIG. 1, wherein a secondary supply source of gaseous agent is shown discharging a supplemental amount of the gaseous agent into the enclosure that is sufficient to restore the concentration of gaseous agent in the enclosure to the predetermined initial level;

FIG. 5 is a schematic representation of a gaseous agent fire extinguishing system in which the primary supply source and the secondary supply source are connected to different pipe systems that terminate at different nozzles, and wherein the secondary supply source consists of a single secondary agent supply reservoir discharged by periodic actuation of an on-off control valve;

FIG. 6 is a schematic representation of a gaseous agent fire extinguishing system in which the primary supply source and the secondary supply source are connected in series, and wherein the secondary supply source includes a plurality of secondary agent supply reservoirs;

FIG. 7 is a schematic representation of a gaseous agent fire extinguishing system in which the primary supply source and the secondary supply source are connected to different pipe systems that terminate at different nozzles and wherein the secondary supply source includes a plurality of secondary agent supply reservoirs;

FIG. 8 is a schematic representation of a gaseous agent fire extinguishing system in which the primary supply source and the secondary supply source are connected in parallel, and wherein the secondary supply source includes a plurality of secondary agent supply reservoirs;

FIG. 9 is a graphical representation showing continuous extended discharge of a gaseous agent into a protected enclosure in accordance with a prior art fire protection system; and

FIG. 10 is a graphical representation showing step-wise extended discharge of a gaseous agent into a protected enclosure in accordance with an embodiment of the subject invention.

### DETAILED DESCRIPTION OF PREFERRED EMBODIMENTS

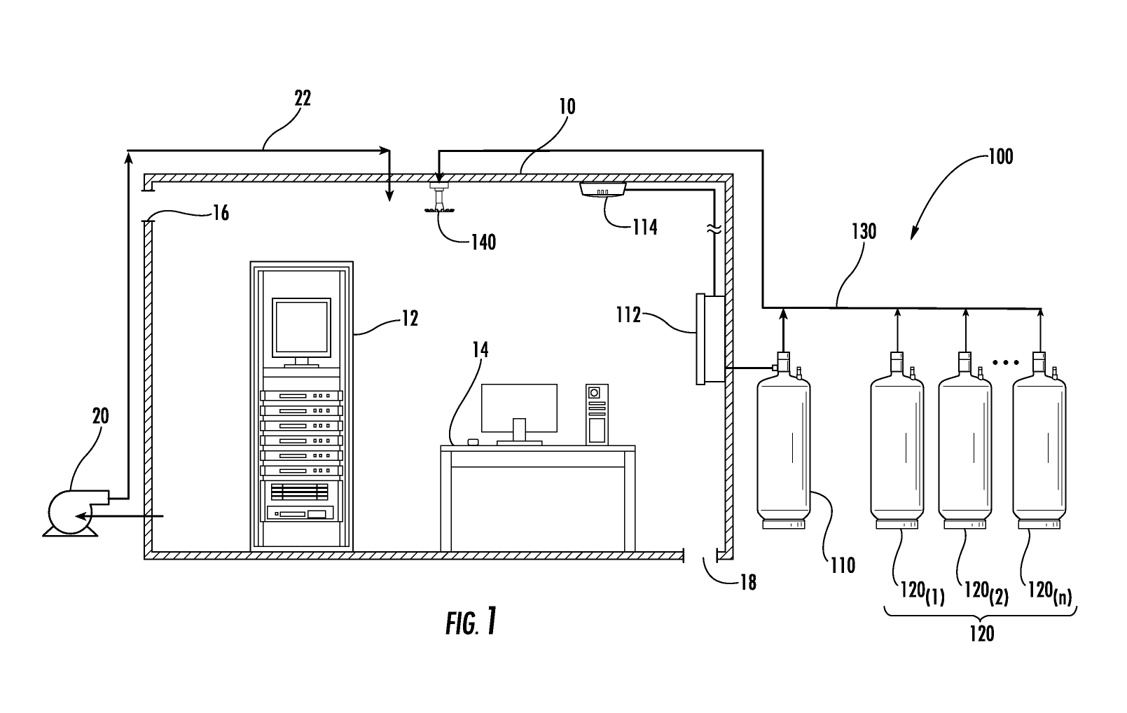

Referring now to the drawings, wherein like reference numerals identify similar structural features or aspects of the subject invention, there is illustrated in FIG. 1 a schematic representation of an enclosure 10 protected by a gaseous agent fire extinguishing system constructed in accordance with the subject disclosure and designated generally by reference numeral 100. The gaseous agent utilized in this fire extinguishing system is preferably selected from a variety of commercially available gaseous agents having a wide range of properties including, for example, HFC-227e, HFC-125, FK-5-1-12 and IG-541. Other known fire suppression agents can be employed without departing from the scope of the subject disclosure

Referring to FIG. 1, the protected enclosure 10 has a fixed volume “V” and a height “H” from floor to ceiling. Within the enclosure 10 there are situated two protected assets. These include protected asset 12 and protected asset 14. Protected asset 12 is depicted as a computer rack cabinet having a height h₁ and protected asset 14 is depicted as a workstation having a height h₂. As illustrated, the enclosure 10 includes two leakage openings, including, for example, an upper leakage opening 16 and a lower leakage opening 18. Those skilled in the art will readily appreciate that a leakage opening in such an enclosure could take the form of a vent or duct, or an unsealed opening associated with a door or window. The enclosure 10 also includes a HVAC blower 20 for circulating air throughout the enclosure 10 by way of a ventilation system 22.

In accordance with applicable NFPA codes and regulations (i.e., Annex C of NFPA 2001 and Annex E of ISO 14520 a), enclosure 10 has a defined hold-time, which, as defined above, is the period of time required for agent concentration to drop to (or below) a specified level. For example, the hold-time for a given enclosure could be equal to 10 minutes, providing ample time for fire fighters to arrive. More particularly, the hold time is the time between the end of agent discharge and the time at which the agent concentration level has decreased a defined level or fraction of the minimum design concentration (MDC) for a given volume “V”, either (a) at a designated height in the enclosure due to a descending interface of a quiescent air-enriched atmosphere, or (b) as the average concentration of agent in the enclosure where continued post-discharge air circulation, for example, from HVAC blower 20, causes the agent concentration level to be equal throughout the volume of the enclosure.

With continuing reference to FIG. 1, the enclosure 10 is protected by fire extinguishing system 100, which includes a programmable controller 112 and a smoke detector 114. The controller 112 may be located within or adjacent to the enclosure 10, or it may be located at a remote location. It is envisioned that the controller 112 may be programmed on site or from a remote location. The smoke detector 114 is located within the enclosure 10 and is operatively connected to the controller 112. This connection can be hard wired or wireless.

The fire extinguishing system 100 further includes a primary agent supply source 110 and a secondary agent supply source 120. In accordance with the subject disclosure, the secondary agent supply source 120 includes a plurality of secondary agent supply reservoirs 120_{(1, 2, . . . n)}. The number of secondary supply reservoirs or vessels can vary depending upon the application and/or operating environment.

The primary agent supply source 110 can take the form of a single agent supply reservoir or vessel as shown for example in FIG. 1. Alternatively, the primary agent supply source 110 could include multiple primary agent supply reservoirs. These agent supply reservoirs could be connected to a manifold so that gaseous agent can be distributed to nozzles at multiple locations within the protected enclosure by way of a piping system associated with the manifold.

Referring again to FIG. 1, the primary agent supply source 110 contains an initial amount of a gaseous agent sufficient to achieve a predetermined initial concentration level of gaseous agent in the enclosure 10 for the hold time. Each of the secondary agent supply reservoirs 120_{(1, 2, . . . n)} of the secondary agent supply source 120 contains a supplemental amount of the gaseous agent sufficient to restore the concentration of gaseous agent in the enclosure 10 to the predetermined initial level, and thereby extend fire protection for the enclosure 10 for a period beyond the enclosure's hold time.

The single supply reservoir of the primary agent supply source 110 and the plural agent supply reservoirs 120_{(1, 2, . . . n)} of the secondary supply source 120 are fluidly associated with a piping system 130. As discussed in more detail below, the way in which the primary and secondary agent supply sources 110, 120 are arranged with respect to one another and within the piping system 130 can vary depending upon the application.

The piping system 130 is connected to at least one distribution nozzle 140 located within the enclosure 10, preferably near the upper boundary thereof. The controller 112 is operatively connected to the piping system 130 and/or the primary and secondary supply sources 110, 120 for controlling the discharge of gaseous agent therefrom, in response to a signal received from the smoke detector 114 or from a remote location. These connections can be hard wired or wireless.

More particularly, the controller 112 is programmed to discharge the primary agent supply reservoir and to sequentially discharge the plurality of secondary agent supply reservoirs 120_{(1, 2, . . . n)} into the enclosure 10. It is envisioned that the controller 112 can be programmed to sequentially discharge the plurality of secondary agent supply reservoirs 120_{(1, 2, . . . n)} into the enclosure 10 in time intervals of equal duration, or in time intervals that vary in duration, depending upon the application. For example, the controller 112 may be adapted and configured to detect a real-time change in the leakage characteristics of the enclosure 10 (e.g., detecting an open window sensor) warranting a change in the discharge profile for secondary agent supply source 120, particularly in the upper boundaries of the enclosure. It is envisioned that controller 112 may also be adapted and configured to detect or otherwise sense a change in the concentration of gaseous agent in the enclosure, warranting a change in the discharge profile for the secondary agent supply source 120.

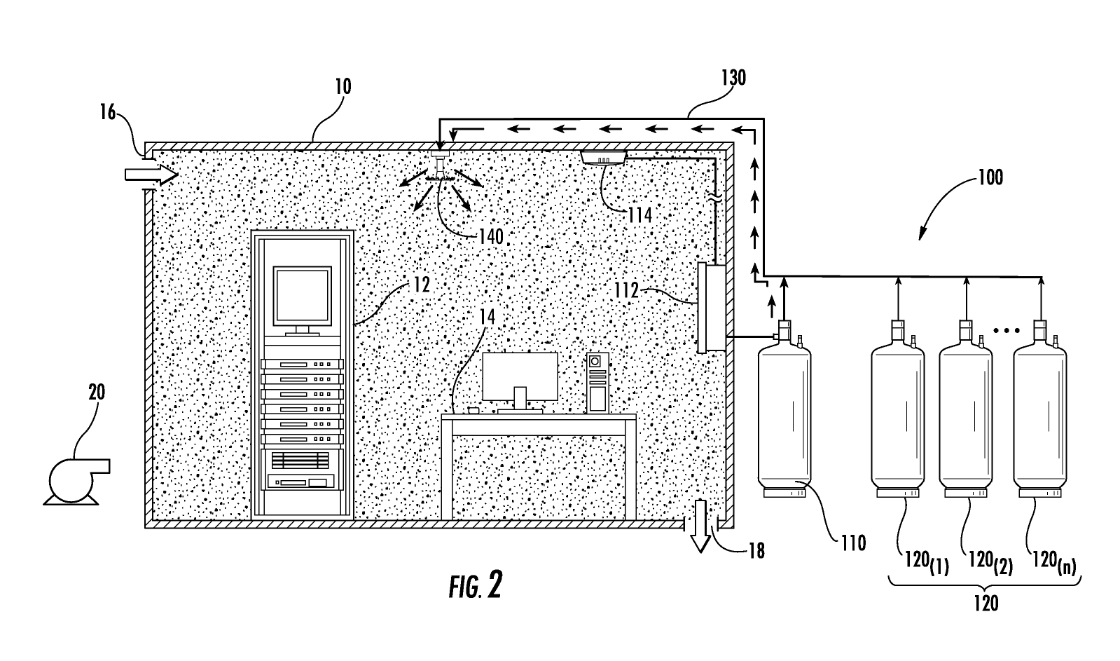

Referring now to FIG. 2, in operation, when the primary supply source 110 of fire extinguishing system 100 discharges an initial amount of a gaseous agent into enclosure 10 through a spray nozzle 120 or distributor, there is a sufficient amount of gaseous agent in the enclosure to achieve a predetermined initial concentration level of 100% of the MDC of the enclosure 10. After this initial discharge, a relatively uniform mixture of agent and air remains inside the enclosure 10 for a period of time, preferably equal to the enclosure's rated hold time.

However, the density of the agent/air mixture in the enclosure 10 is greater than the density of the air surrounding the enclosure 10. This difference exerts a positive hydrostatic pressure at the lower boundaries of the enclosure 10, forcing the air/agent mixture to egress from the enclosure 10 through the available lower leakage opening 18. This leakage creates a negative pressure differential at the upper boundaries of the enclosure 10. Since the volume “V” of the enclosure 10 is fixed, as agent leaks out of the lower leakage opening 18, an equal amount of air from outside the enclosure ingresses into the upper leakage opening 16. Consequently, the concentration of agent within the enclosure 10 decreases over time.

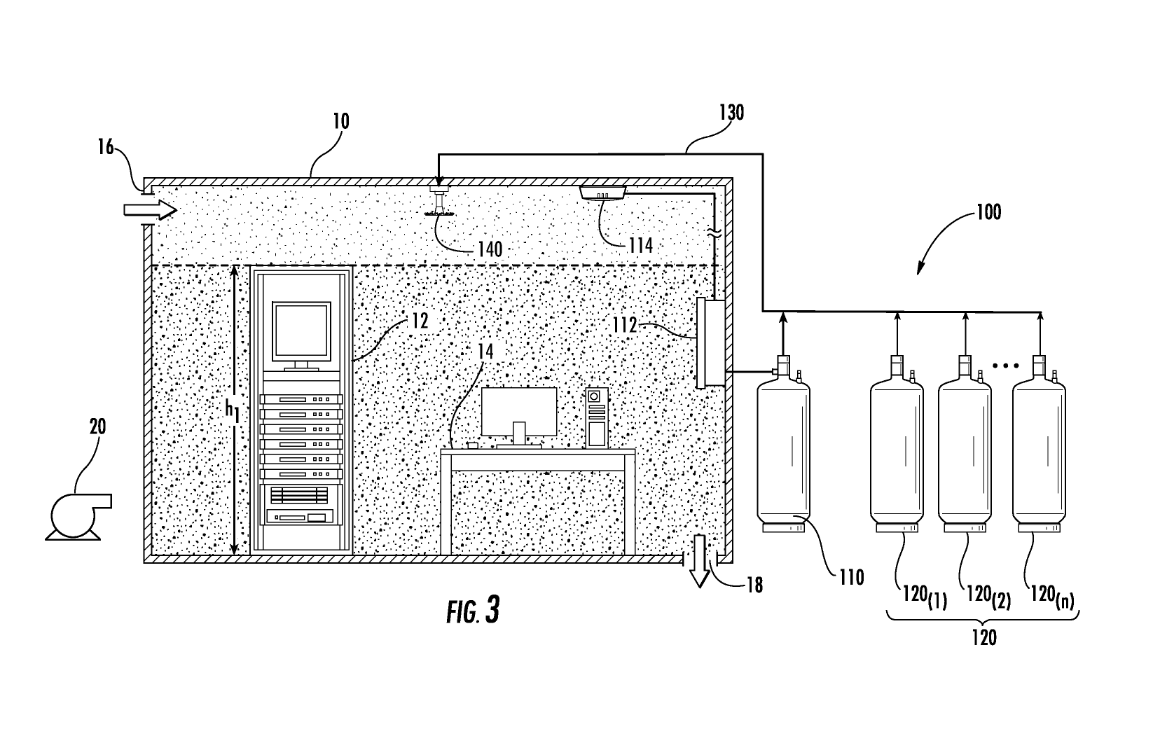

More particularly, as shown in FIG. 3, a few minutes after the initial agent discharge shown in FIG. 2, the concentration of gaseous agent has decreased in the upper part of the enclosure 10. By way of non-limiting example, the concentration of gaseous agent in the enclosure 10 has decreased to about 85% of the MDC at the height h₁ of the enclosure, which is the height of the protected asset 12. Thereupon, under the applicable fire protection standards, the protective atmosphere within enclosure 10 is deemed deficient. This requires remedial action to restore the concentration of gaseous agent to the initial predetermined level.

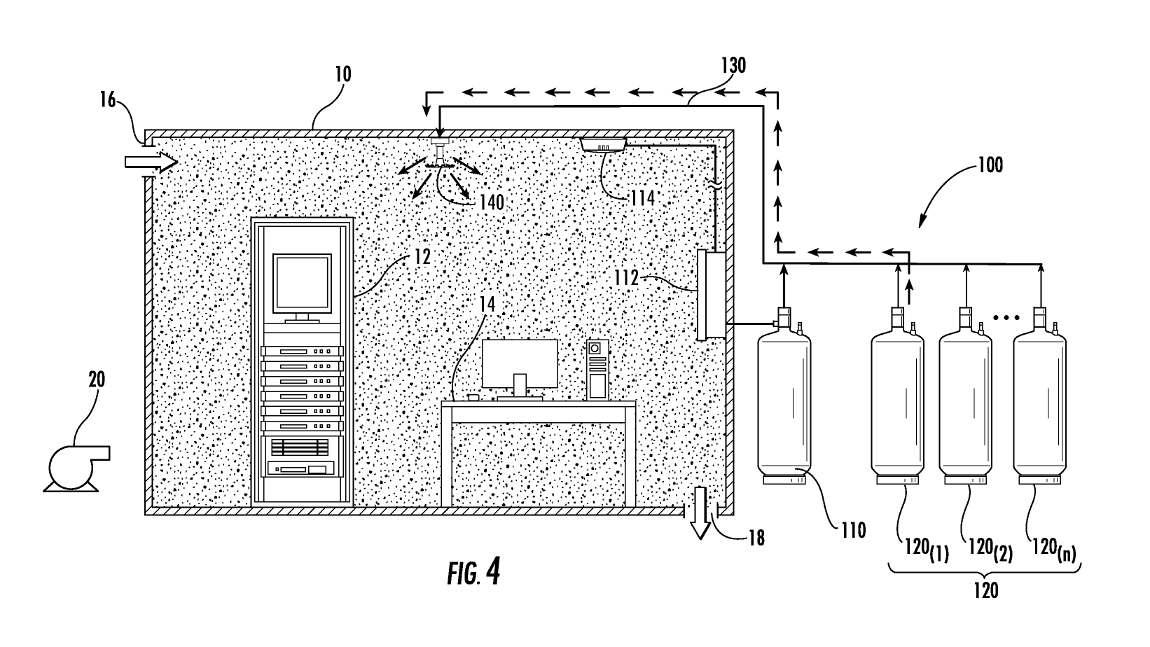

FIG. 4 is an illustration of the protected enclosure 10, when the first secondary supply source 120₍₁₎ discharges a supplemental amount of gaseous agent into the enclosure 10 that is sufficient to restore the concentration of gaseous agent in the enclosure 10 to the predetermined initial level of 100% of the MDC. In this example, the single supply reservoir 120₍₁₎ of gaseous agent discharges its entire contents into the enclosure 10 through piping system 130, to extend the hold time for the enclosure.

Referring to FIG. 5, there is illustrated a schematic representation of a gaseous agent fire extinguishing system 200 in which the primary agent supply source 210 and the secondary agent supply source 220 are connected to respective pipe systems 230, 240 that would terminate at different spray nozzles communicating with protected enclosure. This embodiment is similar to embodiment 100 above, in that the primary agent supply source 210 contains an initial amount of a gaseous agent sufficient to achieve a predetermined initial concentration level of gaseous agent in the enclosure 10 (not shown in FIG. 5) for the hold time. This embodiment differs from system 100 in that the secondary agent supply source 220 consists of a single secondary agent supply reservoir which is configured to be discharged through the periodic actuation of an on-off control valve 250.

Control valve 250 is operatively connected to a programmable controller 212. Here, the controller 212 is programmed to open the control valve 250 for time intervals of equal duration or in time intervals that vary in duration, depending upon the application and/or conditions within the enclosure. In either instance, the amount of the gaseous agent that is periodically discharged through activation of the control valve 250 is sufficient to restore the concentration of gaseous agent in the enclosure to the predetermined initial level, and thereby extend fire protection for the enclosure for a period beyond the enclosure's hold time.

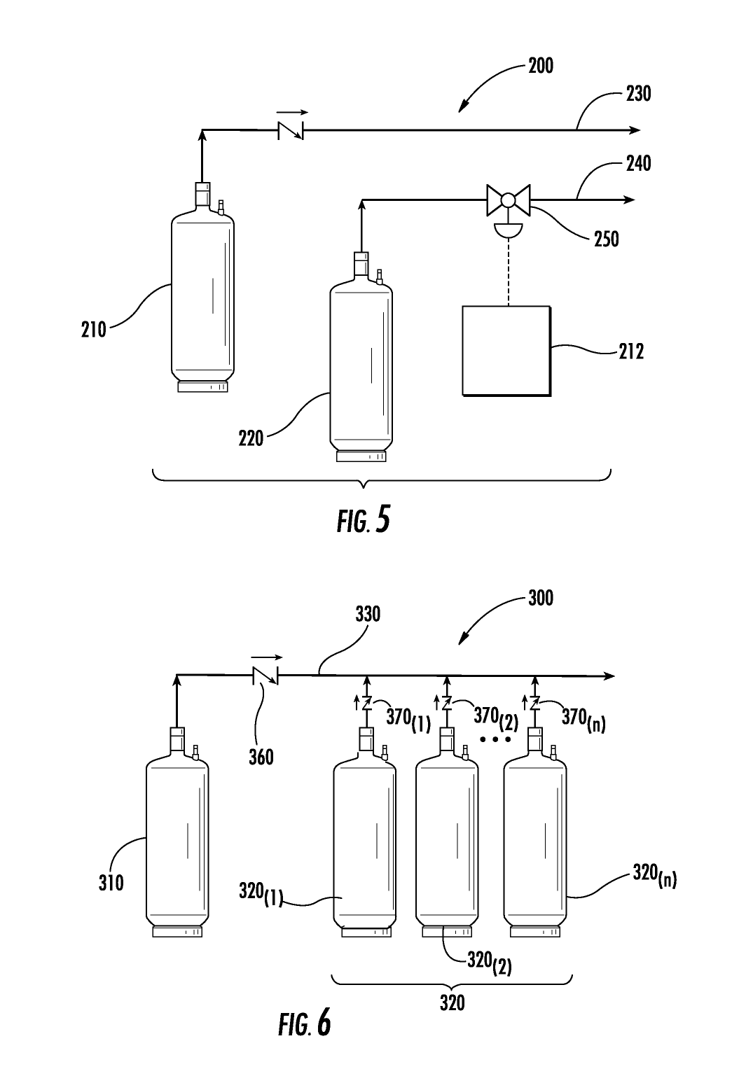

Referring to FIG. 6, there is illustrated a schematic representation of a gaseous agent fire extinguishing system 300 in which the primary agent supply source 310 and the secondary agent supply source 320 are connected in series, along a single piping system 330 that communicates with a protected enclosure . In this embodiment, the secondary supply source 320 includes a plurality of secondary agent supply reservoirs 320_{(1, 2, . . . n)} that are each configured for periodic discharge by a programmable controller (not shown). A check valve 360 fluidly isolates the primary supply source 310 from the secondary supply source 320. Similarly, individual check valves 370_{(1, 2, . . . n)} are associated with each of the secondary agent supply reservoirs 320_{(1, 2, . . . n)} to isolate the secondary reservoirs from one another. In this embodiment as in the previous embodiment, each secondary supply reservoir 320_{(1, 2, . . . n)} contains a supplemental amount of the gaseous agent that is sufficient to restore the concentration of gaseous agent in the protected enclosure to the predetermined initial level provided by the discharge of the primary agent supply source 310.

Referring to FIG. 7, there is a schematic representation of a gaseous agent fire extinguishing system 400 in which the primary agent supply source 410 and the secondary agent supply source 420 are connected to different pipe systems that terminate at respective spray nozzles within the enclosure (not shown). This embodiment is similar to embodiment 200 shown in FIG. 5, except that the secondary agent supply source 420 includes a plurality of secondary agent supply reservoirs 420_{(1, 2, . . . n)} each containing a supplemental amount of the gaseous agent sufficient to restore the concentration of gaseous agent in the enclosure to the predetermined initial level provided by the discharge of the primary supply source 410. Appropriate check valves are also provided to fluidly isolate the supply reservoirs from one another after discharge.

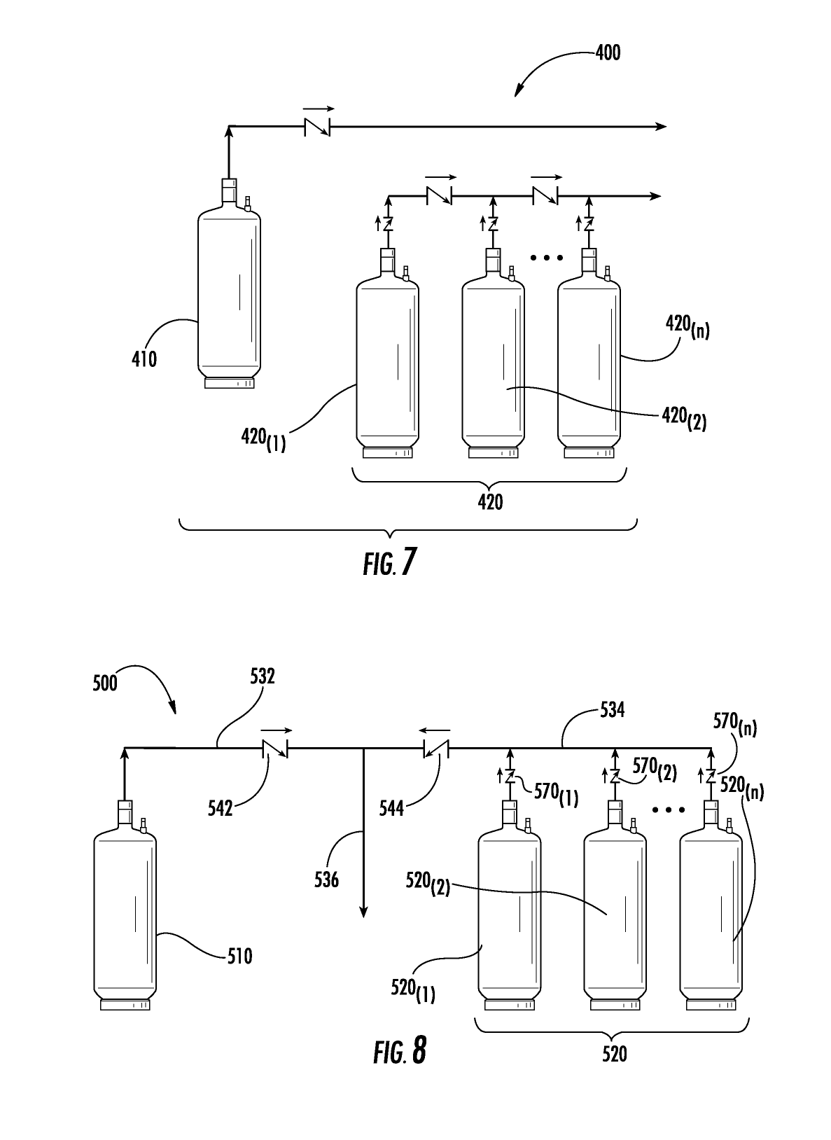

Referring to FIG. 8, there is illustrated a schematic representation of a gaseous agent fire extinguishing system 500 in which the primary agent supply source 510 and the secondary agent supply source 520 are connected in parallel. More particularly, the piping system includes a first conduit 532 associated with the primary agent supply source 510 and a second conduit 534 associated with the secondary agent supply source 520. The first and second conduits 532, 534 are connected into a common discharge conduit 536 that communicates with a discharge nozzle located within the protected enclosure . In this embodiment, check valves 542 and 544 are respectively associated with conduits 532, 534 to fluidly isolate the primary and secondary supply sources 510, 520 from one another. In addition, individual check valves 570_{(1, 2, . . . n)} are associated with each of the secondary agent supply reservoirs 520_{(1, 2, . . . n)} of supply (source 520 to fluidly isolate the secondary reservoirs from one another.

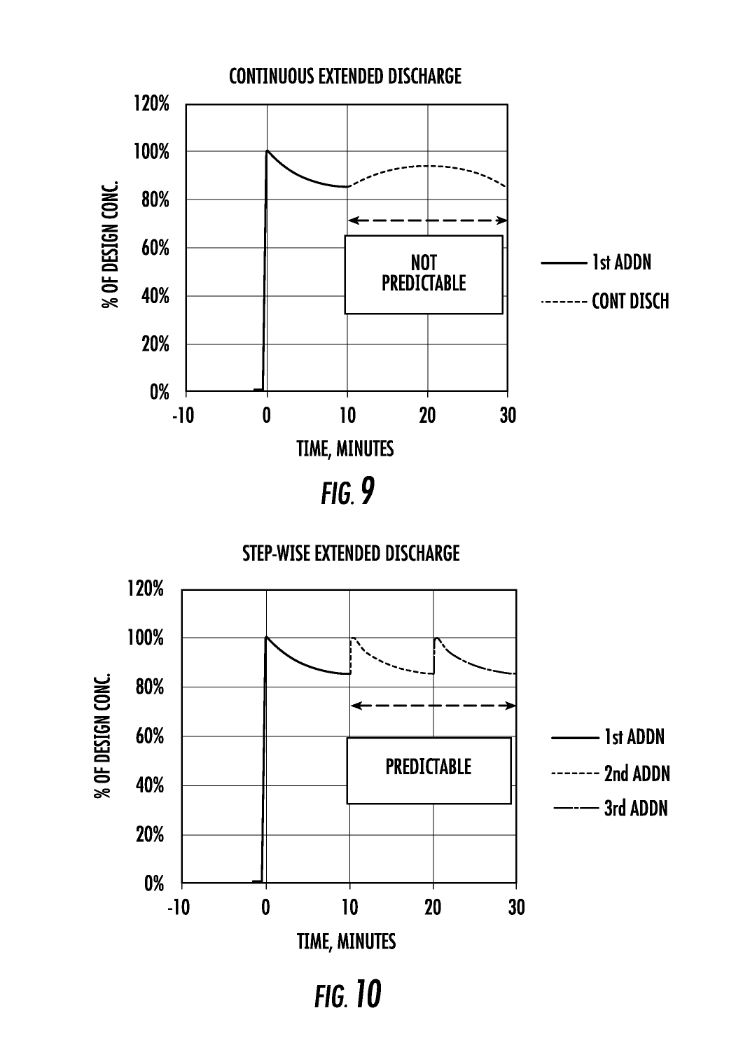

Referring now to FIG. 9, a graphical representation is provided showing the discharge profile of a prior art fire protection system provided with a primary fire extinguishing system and a secondary fire extinguishing system, wherein the secondary fire extinguishing system is designed to continuously discharge a gaseous agent into an enclosure at a relatively slow rate to achieve an extended period of fire protection. This prior art system has several risks associated therewith, including: a) it is typically not tested so there is a chance that it will not operate properly or effectively when employed; b) there is no assurance that there will be adequate turbulence in the room to mix the gases to achieve the extended period of fire protection; c) the discharge rate of the secondary system slows down as the supply cylinder becomes depleted; d) the discharge rate of the secondary system could fall below the enclosure's leakage rate; and e) the gas concentration could fall below the minimum target concentration for the enclosure. Consequently, the extended fire protection afforded by the prior art continuous discharge profile shown in FIG. 9 is relatively unpredictable.

In comparison, FIG. 10 is a graphical representation showing the step-wise extended discharge profile of a fire protection system constructed in accordance with an embodiment of the subject invention. Those skilled in the art will readily appreciate that the step-wise extended discharge profile of the subject invention provides a more predictable degree of fire protection for an enclosure containing protected assets. Moreover, when a gaseous agent is periodically introduced into a protected enclosure (e.g., in 10 minute intervals) in a sufficient amount and for a sufficient duration of time, the concentration of gaseous agent in the enclosure will be repeatedly restored to the predetermined initial level established by the discharge of the primary agent supply source, thereby predictably extending fire protection for the enclosure for a period of time, well beyond the enclosure's hold time.

While the subject invention has been shown and described with reference to preferred embodiments, those skilled in the art will readily appreciate that various changes and/or modifications may be made thereto without departing from the spirit and scope of the subject invention as defined by the appended claims. For example, while the primary agent supply source has been shown and described throughout the specification and drawings as a single agent supply reservoir, it is envisioned that the primary agent supply source can include multiple agent supply reservoirs or vessels.

What is claimed is:

1. A fire protection system for an enclosure, comprising:
a) a controller for regulating the introduction of a gaseous agent into an enclosure having a given hold time;
b) a primary supply source of gaseous agent operatively associated with the controller and configured to discharge an initial amount of a gaseous agent sufficient to achieve a predetermined initial concentration level of gaseous agent in the enclosure for the hold time; and
c) a secondary supply source of gaseous agent operatively associated with the controller and configured to periodically discharge a supplemental amount of the gaseous agent into the enclosure that is sufficient to restore the concentration of gaseous agent in the enclosure to the predetermined initial level and thereby extend fire protection for the enclosure for a period beyond the enclosure's hold time.

2. A system as recited in claim 1, wherein the secondary supply source is a single secondary agent supply reservoir.

3. A system as recited in claim 2, wherein the controller is adapted and configured to periodically discharge a supplemental amount of gaseous agent from the single secondary agent supply reservoir based upon a detected concentration level of gaseous agent in the enclosure.

4. A system as recited in claim 2, wherein a control valve is operatively associated with the secondary supply source and the controller for periodically discharging gaseous agent from the secondary agent supply reservoir.

5. A system as recited in claim 1, wherein the secondary supply source is a plurality of secondary agent supply reservoirs.

6. A system as recited in claim 5, wherein the controller is adapted and configured to sequentially discharge the plurality of secondary agent supply reservoirs into the enclosure.

7. A system as recited in claim 6, wherein the controller is adapted and configured to sequentially discharge the plurality of secondary agent supply reservoirs into the enclosure in time intervals of equal duration.

8. A system as recited in claim 6, wherein the controller is adapted and configured to sequentially discharge the plurality of secondary agent supply reservoirs into the enclosure in time intervals that vary in duration.

9. A system as recited in claim 1, wherein the controller is adapted and configured to discharge a supplemental amount of the gaseous agent into the enclosure for a predetermined period of time.

10. A system as recited in claim 6, wherein the controller is adapted and configured to periodically sequentially discharge the plurality of secondary agent supply reservoirs based upon a detected concentration level of gaseous agent in the enclosure.

11. A system as recited in claim 1, wherein the primary supply source and the secondary supply source are connected in series.

12. A system as recited in claim 11, wherein the primary supply source is located upstream from the secondary supply source.

13. A system as recited in claim 1, wherein at least one check valve is positioned to fluidly isolate the primary supply source from the secondary supply source.

14. A system as recited in claim 1, wherein the primary supply source and the secondary supply source are connected in parallel.

15. A system as recited in claim 1, wherein the primary supply source and the secondary supply source are connected to separate pipe systems terminating at different nozzles communicating with the enclosure.

16. A system as recited in claim 1, wherein the supplemental amount of gaseous agent is sufficient to restore the concentration of gaseous agent in the enclosure to a level at or in excess of a minimum fraction of a minimum design concentration (MDC) at a height of a highest protected hazard component in the enclosure.

17. A method of fire protection for an enclosure, comprising the steps of:
a) introducing an initial amount of a gaseous agent into an enclosure to achieve a predetermined concentration level for a given hold time of the enclosure; and
b) periodically introducing a supplemental amount of the gaseous agent into the enclosure to restore the concentration of gaseous agent in the enclosure to the predetermined level, thereby extending fire protection for the enclosure beyond the enclosure's hold time.

18. A method according to claim 17, wherein the supplemental amount of gaseous agent is periodically introduced into the enclosure for a predetermined period of time.

19. A method according to claim 17, wherein the supplemental amount of gaseous agent is periodically introduced into the enclosure in time intervals of equal duration.

20. A method according to claim 17, wherein the supplemental amount of gaseous agent is periodically introduced into the enclosure in time intervals that vary in duration.

21. A method according to claim 17, wherein the supplemental amount of gaseous agent is periodically introduced into the enclosure based upon a detected concentration level of gaseous agent in the enclosure.

22. A method according to claim 17, further comprising the step of determining a minimum design concentration (MDC) and hold time for the enclosure.

23. A method according to claim 22, wherein the supplemental amount of gaseous agent is periodically introduced into the enclosure in a sufficient amount and for a sufficient duration of time to restore the concentration of gaseous agent to a level at or in excess of a minimum fraction of the MDC at a height of a highest protected hazard component in the enclosure.
